(19) United States
(12) Patent Application Publication
(10) Pub. No.: US 2011/0122389 A1
(43) Pub. Date: May 26, 2011

(54) RADIATION SOURCE, LITHOGRAPHIC APPARATUS AND DEVICE MANUFACTURING METHOD

(75) Inventors: Michel Fransois Hubert Klaassen, Eindhoven (NL); Rogier Herman Mathijs Groeneveld, Eindhoven (NL); Alexander Matthijs Struycken, Eindhoven (NL); Gerardus Hubertus Petrus Maria Swinkels, Eindhoven (NL)

(73) Assignee: ASML Netherlands B.V., Veldhoven (NL)

(21) Appl. No.: 13/055,827

(22) PCT Filed: Jul. 15, 2009
(86) PCT No.: PCT/EP2009/059045

§ 371 Date: Jan. 25, 2011

Related U.S. Application Data
(62) Division of application No. 61/084,759, filed on Jul. 30, 2008.
Application No. 61/084,759 is a division of application No. 61/092,443, filed on Aug. 28, 2008.

(51) Int. Cl. G03B 27/34

(52) U.S. Cl. 355/68

(57) ABSTRACT

A lithographic apparatus includes a source module that include a collector and a radiation source. The collector is configured to collect radiation from the radiation source. An illuminator is configured to condition the radiation, collected by the collector and to provide a radiation beam. A detector is disposed in a fixed positional relationship with respect to the illuminator. The detector is configured to determine a position of the radiation source relative to the collector and a position of the source module relative to the illuminator.

### FIELD

The present invention relates to a lithographic apparatus using radiation of a wavelength shorter than 20 nm, and a device manufacturing method using such radiation.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that example, a patterning device, which is alternatively referred to as a mask or a reticle, may be used to generate a circuit pattern to be formed on an individual layer of the IC. This pattern can be transferred onto a target portion (e.g. including part of one or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include steppers, in which each target portion is irradiated by exposing an entire pattern onto the target portion at one time, and scanners, in which each target portion is irradiated by scanning the pattern through a radiation beam in a given direction (the “scanning” direction) while synchronously scanning the substrate parallel or anti-parallel to this direction.

A theoretical estimate of the limits of pattern printing can be given by the Rayleigh criterion for resolution as shown in equation (1):

$$CD = {k}_{1} * \frac{λ}{{NA}_{PS}} \qquad ( 1 )$$

where λ is the wavelength of the radiation used, NA_{PS} is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA_{PS} or by decreasing the value of k₁.

In order to shorten the exposure wavelength and, thus, reduce the minimum printable size, it has been proposed to use an extreme ultraviolet (EUV) radiation source. EUV radiation sources are configured to output a radiation wavelength of less than 20 nm, and more in particular of about 13 nm. Thus, EUV radiation sources may constitute a significant step toward achieving small features printing. Such radiation is termed extreme ultraviolet or soft x-ray, and possible sources include, for example, laser-produced plasma sources, discharge plasma sources, or synchrotron radiation from electron storage rings.

Extreme ultraviolet radiation and beyond EUV radiation can be produced using, for example, a radiation emitting plasma. The plasma can be created for example by directing a laser at particles of a suitable material (e.g., tin), or by directing a laser at a stream of a suitable gas or vapor (e.g., Xe gas or Li vapor). The resulting plasma emits EUV radiation (or beyond EUV radiation with shorter wavelength), which is collected using a collector such as a focusing mirror or a grazing incidence collector.

The orientation and/or position of the collector will determine the direction in which radiation is directed from the collector (e.g., reflected from the collector). Radiation will need to be accurately directed to different parts of the lithographic apparatus, and it is therefore important for the collector to direct radiation in a specific direction. When a lithographic apparatus is constructed and used for the first time, it may be possible to ensure that the collector directs radiation in such specific direction. However, over time it can be difficult to ensure that the radiation beam is always directed in this specific direction. For instance, movement of parts of the lithographic apparatus (e.g., parts of the radiation source) can shift the direction of radiation. Additionally or alternatively, when parts of the lithographic apparatus are replaced (e.g., for maintenance purposes) even a slight misalignment of replacement parts can shift the direction of radiation.

It is therefore desirable to align or re-align a collector of a radiation source and parts of the lithographic apparatus located further along the path of the radiation beam. Since an illuminator (sometimes referred to as an “illumination system” or “illumination arrangement”) is a part of the lithographic apparatus that receives radiation directed by the collector, it is desirable to align or re-align the collector of the radiation source and the illuminator.

A proposed method of aligning the collector and the illuminator involves attaching light emitting diodes (LEDs) to the collector. A measurement of radiation emitted by the LEDs can be used to determine an orientation (e.g., tilt) and/or position of the collector with respect to a default (or reference) position. However, an issue with this method is that the LEDs may not be robust to withstand a harsh environment surrounding the collector. For instance, high temperatures and prolonged exposure to EUV radiation can quickly damage or destroy the LEDs. Furthermore, the LEDs must be attached to the collector with a high degree of accuracy, with little or no drift in the position of the LEDs over time. Given these conditions, an LED-based implementation is difficult to achieve

### SUMMARY

In an aspect of the invention, there is provided a lithographic apparatus including a source module including a collector and a radiation source constructed and arranged to provide, in use, a radiation emitting plasma, the collector configured to collect radiation from the radiation emitting plasma; an illuminator configured to condition the radiation collected by the collector and to provide a radiation beam; and a detector disposed in a fixed positional relationship with respect to the illuminator, the detector configured to determine a position of the radiation emitting plasma relative to the collector and a position of the source module relative to the illuminator.

In another aspect of the invention, there is provided a device manufacturing method including using a radiation source to generate a radiation emitting plasma; collecting the radiation generated by the radiation emitting plasma with a collector, the radiation source and the collector being part of a source module of a lithographic apparatus; conditioning the radiation collected by the collector with an illuminator to provide a radiation beam; and detecting a position of the radiation emitting plasma relative to the collector and a position of the source module relative to the illuminator.

In yet another aspect of the invention, there is provided a detector configured to determine a position of a radiation emitting plasma relative to a collector and a position of a source module relative to an illuminator in a lithographic apparatus, the source module including the collector and a radiation source constructed and arranged to provide the radiation emitting plasma, the collector configured to collect radiation from the radiation emitting plasma, and the illuminator configured to condition the radiation collected by the collector and to provide a radiation beam, the detector including a first branch including a plurality of first sensors mounted to a first surface of the illuminator, the plurality of first sensors configured to determine the position of the radiation emitting plasma relative to the collector and the rotational orientation of the source module relative to the illuminator; and a second branch including a plurality of second sensors mounted to a second surface of the illuminator, the plurality of second sensors configured to determine the position of the source module relative to the illuminator and to determine the position of the radiation emitting plasma relative to the collector.

### BRIEF DESCRIPTION OF THE DRAWINGS

Embodiments of the present invention will now be described, by way of example only, with reference to the accompanying schematic drawings in which corresponding reference symbols indicate corresponding parts, and in which:

FIG. 1 schematically depicts a lithographic apparatus according to an embodiment of the invention;

FIG. 2 schematically depicts a source module and an illuminator in accordance with an embodiment of the invention;

FIG. 3 schematically depicts relative positions of a collector and a faceted optical element of a lithographic apparatus in accordance with an embodiment of the invention;

FIG. 4 depicts a source module including a radiation emitting plasma and a collector, an illumination module and a detection and alignment system in accordance with an embodiment of the invention;

FIG. 5a depicts a far field change due to a source module displacement in accordance with an embodiment of the invention;

FIG. 5b depicts a far field changes due to an axial plasma displacement in accordance with an embodiment of the invention;

FIG. 5c depicts a far field change due to lateral a plasma displacement in accordance with an embodiment of the invention;

FIG. 6 shows the imaging branch in accordance with an embodiment of the invention;

FIG. 7 schematically illustrates the difference between sagittal and meridional magnifications in accordance with an embodiment of the invention; and

FIG. 8 schematically illustrates a detection scheme using two orthogonal sensor—mirror pairs to separate rigid and plasma movements in accordance with an embodiment of the invention.

### DETAILED DESCRIPTION

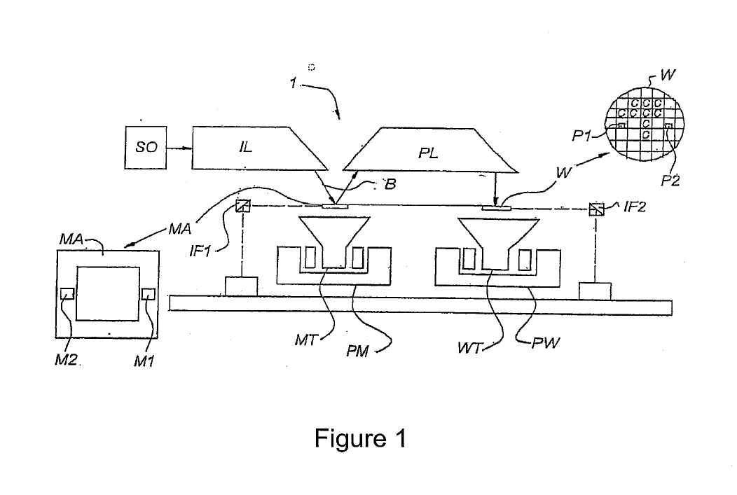

FIG. 1 schematically depicts a lithographic apparatus 1 according to an embodiment of the present invention. The apparatus 1 includes an illumination system (illuminator) IL configured to condition a radiation beam B (e.g. EUV radiation). A patterning device support (e.g. a mask table) MT is configured to support a patterning device (e.g. a mask) MA and is connected to a first positioning device PM configured to accurately position the patterning device in accordance with certain parameters. A substrate table (e.g. a wafer table) WT is configured to hold a substrate (e.g. a resist-coated wafer) W and is connected to a second positioning device PW configured to accurately position the substrate in accordance with certain parameters. A projection system (e.g. a reflective projection lens system) PL is configured to project the patterned radiation beam B onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support MT holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system.

Any use of the terms “reticle” or “mask” herein may be considered synonymous with the more general term “patterning device.”

The term “patterning device” as used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” as used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of a vacuum. Any use of the term “projection lens” herein may be considered as synonymous with the more general term “projection system”.

As here depicted, the apparatus is of a reflective type, for example employing a reflective mask. Alternatively, the apparatus may be of a transmissive type, for example employing a transmissive mask.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives radiation from a source module SO. The source module SO and the illuminator IL may be referred to as a radiation system. The source module SO generally includes a collector and a radiation source constructed and arranged to provide, in use, a radiation emitting plasma.

The illuminator IL may include an adjusting device AD (not shown in FIG. 1) configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN. The illuminator may be used to condition the radiation beam, to have a desired uniformity and intensity distribution in its cross-section.

The radiation beam B is incident on the patterning device (e.g., mask) MA, which is held on the patterning device support (e.g., mask table) MT, and is patterned by the patterning device. After being reflected by the patterning device (e.g. mask) MA, the radiation beam B passes through the projection system PL, which focuses the beam onto a target portion C of the substrate W. With the aid of the second positioning device PW and a position sensor IF2 (e.g. an interferometric device, linear encoder or capacitive sensor), the substrate table WT can be moved accurately, e.g. so as to position different target portions C in the path of the radiation beam B. Similarly, the first positioning device PM and a position sensor IF1 (e.g. an interferometric device, linear encoder or capacitive sensor) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long-stroke module (coarse positioning) and a short-stroke module (fine positioning), which form part of the first positioning device PM. Similarly, movement of the substrate table WT may be realized using a long-stroke module and a short-stroke module, which form part of the second positioning device PW. In the case of a stepper, as opposed to a scanner, the patterning device pattern support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions. These are known as scribe-lane alignment marks. Similarly, in situations in which more than one die is provided on the patterning device (e.g. mask) MA, the patterning device alignment marks may be located between the dies.

The depicted apparatus could be used in at least one of the following modes:

1. In step mode, the patterning device support (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the patterning device support (e.g. mask table) MT and the substrate table WT are scanned synchronously while a pattern imparted to the radiation beam is projected onto a target portion C (i.e. a single dynamic exposure). The velocity and direction of the substrate table WT relative to the patterning device support (e.g. mask table) MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

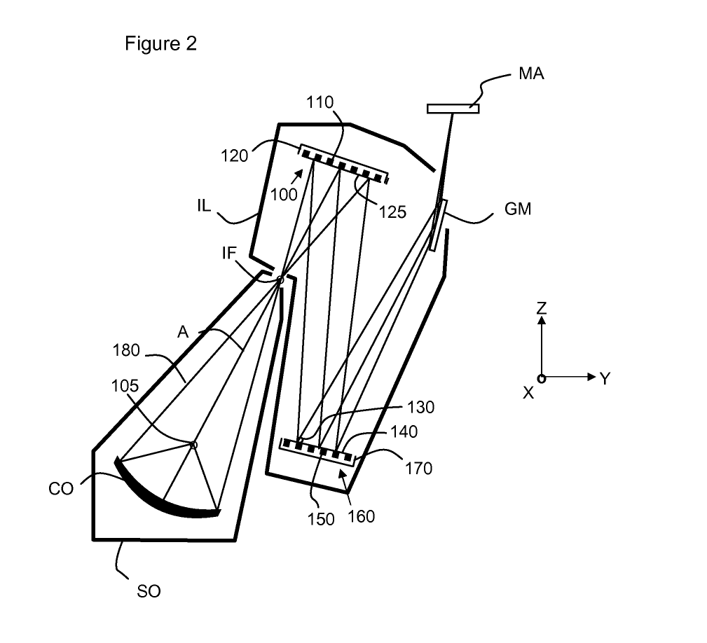

FIG. 2 shows a more detailed, but still schematic depiction of the illuminator IL and the source module SO shown in and described with reference to FIG. 1. FIG. 2 shows the beam path of a radiation beam passing through an illuminator IL with two faceted optical elements 100 and 160 in reflective representation. The beam path is schematically indicated by an axis A. The axis A connects a first and second focal point associated with a collector CO. A radiation emitting plasma 105, also referred to hereinafter s the emission point 105 of the radiation source module SO, is ideally disposed at the first focal point of the collector. Radiation emitted from the emission point 105 of the radiation source module SO, is collected by the collector mirror CO and converted into a convergent light bundle centered around the axis A. An image of the emission point 105 is ideally located at the second focal point; the image at its nominal position is also referred to as the intermediate focus IF. A first optical element 100 includes field raster elements 110 that are arranged on a first raster element plate 120, also referred to as the Field Facet Mirror frame or FFM frame. The field raster elements 110 effectively constitute a (facetted) optical surface, referred to as optical surface 125, or Field Facet Mirror surface, or FFM surface. Field raster elements 110 divide the radiation beam impinging on first optical element 100 into a plurality of light channels and create secondary light sources 130 at corresponding pupil raster elements 150 of a second optical element 160. The pupil raster elements effectively constitute a second (facetted) optical surface, referred to as optical surface 140, or Pupil Facet Mirror surface, or PFM surface. Pupil raster elements 150 of second optical element 160 are arranged on a pupil raster element plate 170, also referred to as the Pupil Facet Mirror frame or PFM frame. The secondary light sources 130 are disposed in a pupil of the illumination system. Optical elements not shown in FIG. 2, downstream of second optical element 160, may serve to image the pupil onto an exit pupil of the illuminator IL (not shown in FIG. 2). An entrance pupil of a projection system coincides with the exit pupil of the illuminator IL (in accordance with so-called “Köhler illumination”). The reflective illuminator IL system can further include optical elements such as, for example, a grazing-incidence field mirror GM, which is constructed and arranged for field-imaging and field-shaping.

Raster elements 110 and 150 of first and second optical elements 100 and 160, respectively, are constructed as mirrors. Raster elements 110 and 150 are arranged on raster element plates 120 and 170, respectively, with a particular orientation (e.g., position and angle of tilt). With a pre-selected orientation (e.g., angle of tilt) of individual field raster elements 110 on field raster element plate 120, it is possible to fix the one-to-one assignment of each element in field raster elements 110 to corresponding pupil raster elements 150 on pupil raster element plate 170.

For reducing non-uniformity of the illumination at the object plane coincident with the mask MA, the assignment of field raster elements 110 to pupil raster elements 150 can differ from an assignment as shown in FIG. 2 by dotted lines 180.

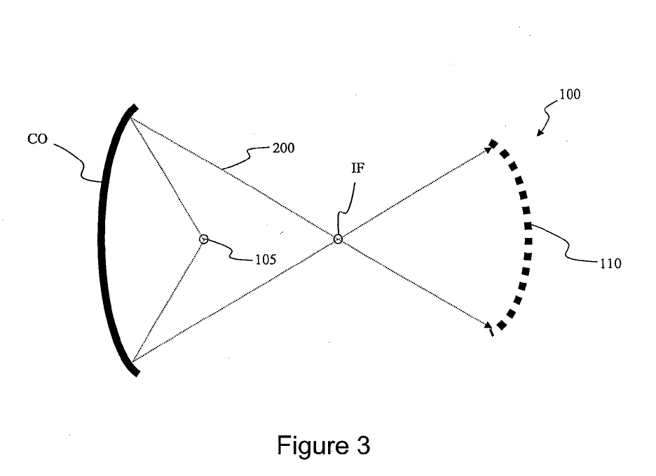

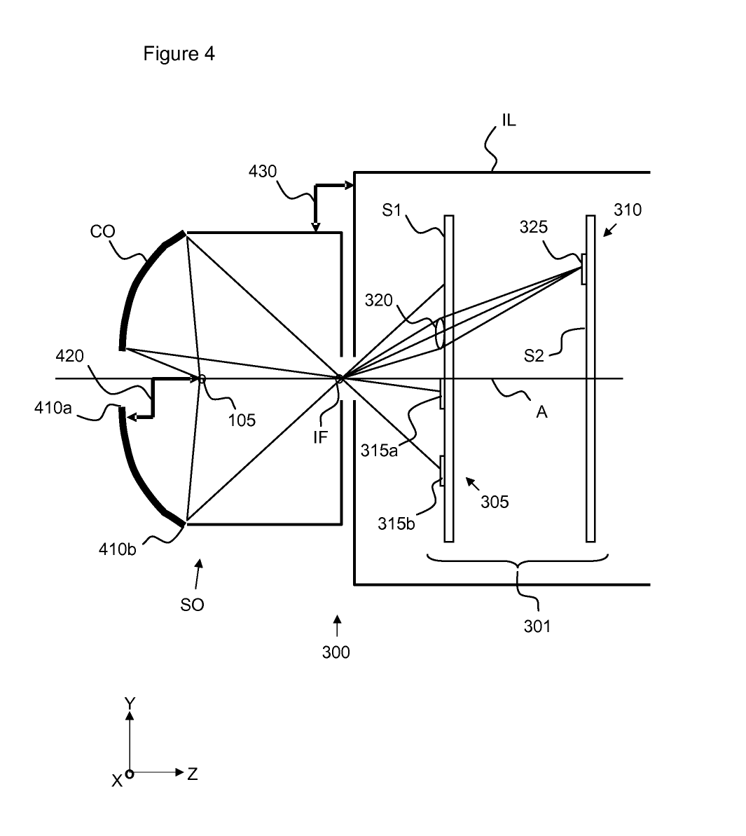

FIG. 3 schematically depicts the collector CO and its position relative to first optical element 100. Radiation 200 is shown as being emitted from emission point 105 and directed by the collector CO towards first optical element 100. It is desirable for the collector CO to direct radiation 200 in a specific direction. It is also desirable that the specific direction is constant during use of the lithographic apparatus so that any element of the lithographic apparatus that is configured to take into account the direction in which radiation 200 is directed can function as intended. As discussed above, it is therefore desirable to provide a method and apparatus which allows for the alignment or re-alignment of the collector CO and the illuminator IL (or, more generally, a part of the illuminator IL) so that the radiation is focused in a specific direction. To ensure good optical performance of a EUV lithographic system, it is desirable that the radiation emitting plasma 105 be accurately aligned relative to the collector CO and that the source module SO be accurately aligned to the illuminator IL. In accordance with an embodiment of the invention, and as schematically illustrated in FIG. 4, there is provided a detector system 301, also referred to hereinafter simply as a “detector” which is part of an aligner or alignment system 300, and which is configured to detect and measure the position of the radiation emitting plasma 105 relative to the collector CO and the position and orientation of the source module SO relative to the illuminator IL. An alignment action (including changing a position and/or orientation of an element such as the plasma, the collector and the source module) may be based on aforementioned measured position(s), or orientation(s) or a combination thereof. In FIG. 4, the Z-direction is defined as being parallel to the axis A (see also FIG. 2). The intermediate focus IF is the origin of the X,Y,Z-coordinate system. The position of the radiation emitting plasma 105 relative to the collector CO has three independent translational degrees of freedom, associated respectively with a translation parallel to the X, Y, and Z axis. An actuator, indicated by the arrow 420, is constructed and arranged to apply position changes along the X,Y, and Z axis to the plasma source point 105. The position of the source module relative to the illuminator has at least five degrees of freedom including again three independent translational degrees of freedom parallel to the X, Y, and Z axis, respectively. The source module SO further has at least two independent rotational degrees of freedom, denoted by Rx and Ry, and associated with a rotation around the X axis and the Y axis respectively. An actuator, indicated by the arrow 430, is constructed and arranged to apply position changes along the X,Y, and Z axis and rotations Rx and Ry to the source module SO.

Hence, the rotational degree of freedom (Rx, Ry) allows for a rotation of the source module relative to the illuminator around the intermediate focus IF.

The position of the plasma relative to the collector can be controlled in the X, Y, and Z directions using the actuator 420. The position of the source module (which includes the radiation source for providing the radiation emitting plasma) relative to the illuminator can be controlled, using actuator 430, in the X,Y, and Z directions as well, and the orientation of the source module can further be controlled in the rotational degrees of freedom (Rx, Ry, Rz), where Rz is a rotation around the Z-axis. Actuators 420 and 430 can be used to perform the desired positioning. The actuators 420 and 430 may receive a feedback signal from the alignment system 300.

In an embodiment, the alignment system 300 includes an 8 degrees of freedom measurement system. The detector system 301 is configured to measure the plasma position in the 3 degrees of freedom (X, Y, Z) relative to the collector and to measure the source module position relative to the illuminator in the 5 degrees of freedom (X,Y, Z, Ry, Rx). The rotation around the Z-axis may not be measured by the detector.

All degrees of freedom are defined with respect to the intermediate focus IF (which coincides with the second focal point of the collector CO, i.e. the nominal position of the image of the plasma 105). The intermediate focus IF is the origin of the X,Y,Z co-ordinate system. Hence, a rotational degree of freedom (Rx, Ry) is defined as a rotation of the source module SO relative to the illuminator IL around the intermediate focus IF. The movement degrees of freedom of the radiation emitting plasma 105 are defined relative to the first focal point of the collector CO.

Referring to FIG. 4, this figure shows a schematic representation of an alignment system 300 including a detection system 301, a source module SO and an illuminator IL in accordance with an embodiment of the invention. As shown in FIG. 4, the source module SO illuminates optical surfaces S1, S2 of the illuminator IL. The source module SO includes a plasma source emission point 105 located at the first focal point of the collector mirror CO. The collector mirror CO may have an elliptical shape. A second focal point of the source module SO corresponds to the intermediate focus IF. The optical surfaces S1, S2 are mounted at a position downstream the intermediate focus IF.

The alignment system 300 includes a detector 301 comprising a plurality of edge sensors on the first optical surface S1 of the illuminator IL to measure tilt and position alignment, and a plurality of position sensors on the second optical surface S2 to measure position alignment only. In this manner, it is possible to obtain tilt and position alignment information.

As shown in FIG. 4, the detector 301 of the alignment system 300 consists of two branches 305, 310. The detector includes a first branch 305 including a plurality of first sensors 315a and 315b mounted to a first surface S1 of the illuminator IL, the plurality of first sensors 315a,b configured to determine the position of the radiation emitting plasma 105 relative to the collector CO. The plurality of first sensors 315a,b of the first branch 305 includes 6 edge detectors (1 dimensional position sensitive device) sampling the inner and outer edge of the far field at the first optical surface S1. As edge detector a one dimensional position sensitive device (1D PSD) can be used. Such a device senses along one direction a position of a change of incident radiation intensity.

In the embodiment, the first optical surface S1 is a Field Facet Mirror surface 125, including a FFM frame 120 and a plurality of facet mirrors 110. It is appreciated, however, that surface S1 is not necessarily a FFM surface; a sufficient condition for proper functioning of the first branch detectors 315a,b is that surface S1 is disposed in a Fraunhofer diffraction far-field with respect to the intermediate focus IF. The light spot at the first optical surface S1, as provided by the radiation emitting plasma, or by an alternative radiation source provided at the location of the plasma) has an inner and an outer edge due to the fact that the collector mirror CO has an annular shape that includes an inner diameter 410a and an outer diameter 410b. The first branch 305 has 3 edge detectors located at the inner edge of the light spot on S1, and 3 detectors located at the outer edge. The inner edge is an inner bright-dark radiation intensity change, and the outer edge is an outer bright-dark radiation intensity change. FIG. 4 shows an inner edge detector 315a and an outer edge detector 315b. The first optical surface S1 is illuminated by a broad light spot (having annular sections) that can be correctly centered. In this manner, the emission point 105 can be aligned in position with respect to the collector CO, and the source module SO can be aligned in tilt with respect to the illuminator IL.

The second branch 310 includes a plurality of second sensors mounted to the second surface S2 of the illuminator. In the embodiment, the second optical surface S2 corresponds to the PFM surface 140 in FIG. 2. The second sensors are configured to determine the position of the source module SO relative to the illuminator IL. The second sensors are two dimensional position sensitive devices (2D PSD) arranged to measure a position of the light spot at the intermediate focus IF. To do so, the FFM frame or surface S1 is provided with three mirrors 320 that image the light spot present at the intermediate focus IF on the 2D PSDs 325. FIG. 4 schematically shows one of the mirrors 320 that images the light spot at the intermediate focus on a 2D PSD 325. The mirror 320 is drawn as a lens, in FIG. 4, for reason of simplicity; in a reflective system it may embodied like a field raster element 110, as shown in FIG. 2. The 2D PSDs are located on the second optical surface S2. The second optical surface S2 is a PFM surface. In an embodiment, three 2D PSDs are used. Each 2D PSD senses along two directions (e.g. the X and Y direction) a position of a bright spot in a less bright or substantially dark background. As three sensors are used to detect the image of the radiation emitting plasma 105 at the intermediate focus IF from different angles, it is possible to determine the plasma position in X and Y (with respect to the collector CO) and the source module position in X-Y-Z (with respect to the illuminator IL) as well as plasma-Z and rigid-Z positions.

The alignment system 300 of FIG. 4 includes a dual edge detection system that allows measurement of the plasma position in X-Y-Z (with respect to the collector), Z-position of the source module (with respect to the illuminator) and combined tilt and position in X and Y of the source module (with respect to the illuminator). The mirror-PSD system 310 (the second branch) including the mirror-PSD pair as illustrated in FIG. 4 and consisting of the mirror 320 and the detector 325, and the edge detection system 305 (the first branch) including the detectors 315a,b together deliver all alignment parameters of interest: plasma position with respect to the collector CO along X, Y, Z-axes, and the source module position along X, Y, Z-axes and tilt (Rx, Ry) around X- and Y-axes with respect to the illuminator IL.

The principle of operation of the first branch 305 of the dual edge detection method will now be explained.

Both the outer and inner edge positions move together in unison (1:1) when the source module SO moves laterally with respect to axis A relative to the illuminator module IL. However, a 1 mm shift may be caused by either a 1 mm translation or a 1 mrad rotation around IF. This means that the edge detection branch 305, or first branch, is capable of measuring lumped degrees of freedom only in the X,Y direction: X+Ry and Y+Rx.

The radius of the inner and outer circle derivable from the inner and outer edge readings of the edge detection system of the first branch 305 allows determination of the source module Z-position and the emission point Z-position. A movement of the source module SO with respect to the illuminator IL may, hereinafter, be referred to as a rigid movement, and a movement of the emission point 105 with respect to the collector may be referred to as a plasma movement. Similarly, such movements along the Z-axis may be referred to as a rigid-Z movement and a plasma-Z movement respectively. In particular, for example, dZr refers to a rigid-Z movement. Moving the source module SO along the longitudinal direction (the Z direction) over a distance dZr causes a change of the radius dSₒᵤₜₑᵣ and dSᵢₙₙₑᵣ of the far field light spot outer and inner radii at surface S1 that is proportional to both the Z-shift dZr and the numerical aperture NAₒᵤₜₑᵣ or NAᵢₙₙₑᵣ of the outer or inner edge of the light spot, respectively. The proportionality is as follows: dSₒᵤₜₑᵣ=NAₒᵤₜₑᵣ*dZr, and dSᵢₙₙₑᵣ=NAᵢₙₙₑᵣ*dZr. Here NAₒᵤₜₑᵣ is, for example, 0.16 and NAᵢₙₙₑᵣ is 0.03:

dSₒᵤₜₑᵣ=0.16*dZr (2a)

dSᵢₙₙₑᵣ=0.03*dZr (2b)

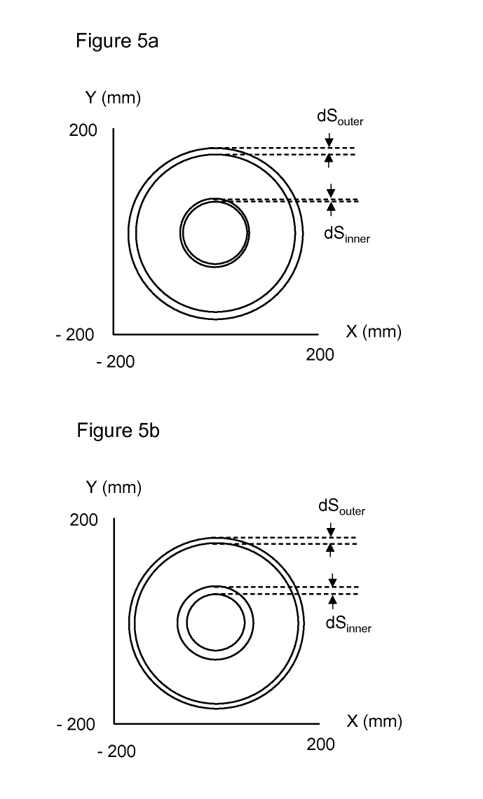

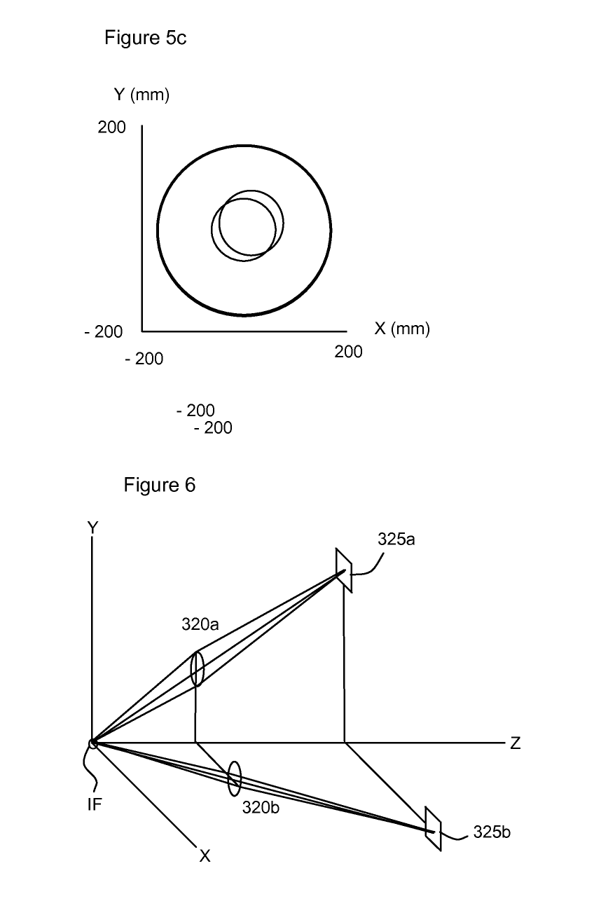

A plasma-Z movement dZp along the Z-direction causes a radial change dSₒᵤₜₑᵣ and dSᵢₙₙₑᵣ that is proportional to the numerical aperture NAₒᵤₜₑᵣ and NAᵢₙₙₑᵣ, dZp, and the longitudinal magnification between dZ and a corresponding movement dZ_{IF} of the image of the emission point 105 at the intermediate focus IF. The light rays ending up at the outer edge region are coming from another angular region from the plasma than the inner edge rays. A Z movement of the plasma is magnified differently for the inner edge rays than for the outer edge rays. The effects of both rigid-Z movement and plasma-Z movement are shown in FIGS. 5a and 5b respectively. The difference in longitudinal magnification for outer and inner edge rays is relevant for the independent determination of the plasma-Z and rigid-Z alignment. The derivation of the longitudinal magnifications Mₒᵤₜₑᵣ and Mᵢₙₙₑᵣ for outer and inner edge rays will be discussed below.

It is appreciated that the principle of measuring positions along the Z axis using the dual edge branch 305 is based on the concepts of longitudinal magnification for outer and inner edge rays. Mₒᵤₜₑᵣ and Mᵢₙₙₑᵣ are respectively the longitudinal magnifications for the outer and inner edge rays. Equation (2b) shows that there is a relatively weak link between a rigid-Z movement dZs and a far field magnification like effect at the inner edge; the value of NAᵢₙₙₑᵣ is relatively small. Therefore, a rigid Z-movement is only readily detectable at the outer edge detectors 315b. FIGS. 5a, b and c schematically illustrate several far field intensity distributions, as can be present in use at or near surface S1, before and after a movement of the radiation emitting plasma 105 relative to the collector CO or the source module SO relative to the illuminator IL. Along the horizontal and vertical axes coordinates X and Y are plotted in mm. FIG. 5a illustrates an effect of an axial movement (along the Z-axis) of the source module SO relative to the illuminator IL. FIGS. 5b and c illustrate effects of respectively axial and lateral movements of the radiation emitting plasma 105 in relation to the collector CO. FIG. 5a illustrates an effect of a 60 mm axial movement of the source module SO relative to the illuminator IL. The change dSₒᵤₜₑᵣ is substantially larger than the change dSᵢₙₙₑᵣ. However, considering a plasma-Z movement, the longitudinal magnification Mᵢₙₙₑᵣ is relatively large for inner edge rays. This compensates for the relatively small value of NAᵢₙₙₑᵣ at the inner edge. For example, with the above mentioned values of NAₒᵤₜₑᵣ and NAᵢₙₙₑᵣ the values of Mₒᵤₜₑᵣ and Mᵢₙₙₑᵣ are such that

dSₒᵤₜₑᵣ=NAₒᵤₜₑᵣ*Mₒᵤₜₑᵣ*dZp=9*dZp, (3a)

dSᵢₙₙₑᵣ=NAᵢₙₙₑᵣ*Mᵢₙₙₑᵣ*dZp=5*dZp. (3b)

Hence, plasma-Z movements manifest themselves as a much more equalized magnification; an outer edge change dSₒᵤₜₑᵣ is only magnified 1.8 times more than an inner edge change dSᵢₙₙₑᵣ. This is shown in FIG. 5b. A comparison of FIGS. 5a and 5b shows that it may not be possible to completely compensate rigid-Z movements by plasma-Z movement, or vice versa. FIG. 5a shows the effect of a +60 mm rigid-Z displacement and FIG. 5b shows the effect of a +1 mm plasma-Z displacement.

A plasma-X and -Y movement can be measured by the dual edge branch 305. As rigid-X, -Y, -Rx, and -Ry movements cause identical shifts of both the inner and outer edges, a plasma-X and -Y movement causes a relative shift of the inner edge center with respect to the outer edge. The effect is shown in FIG. 5c, which shows the impact of a 0.5 mm plasma-X and -Y movement. As can be seen, a plasma deviation manifests itself as a very strong decentering of the inner edge with respect to the outer edge.

The centers of the edges move with respect to each other due to the strong variation of the magnification (in this case transversal) between the inner edge and outer edge rays. In conclusion, the dual edge detection branch determines lumped rigid-X and -Y movements and rigid-Ry, and -Rx rotational movements and is able to provide the plasma-X, -Y, and -Z movements due to a strong magnification variation effect between inner edge and outer edge rays.

Measurements of the plasma position in X and Y (with respect to the collector) and the source module position in X, Y, and Z (with respect to the illuminator) will now be explained, with reference to FIG. 4 and where the optical surface S1 is a FFM surface 125 (see FIG. 2).

The edge detectors 315a,b of the first branch 305 may not discriminate between rigid lateral movements and rigid rotational movements; more specifically, these detectors may not discriminate between rigid-X and -Y movement, and rigid-Rx and -Ry movements. Therefore, it is desirable to have an additional branch 310 that measures either only rigid-Rx and Ry movements or only rigid-X and -Y movements. The latter allows a simple intuitive solution. This measurement branch, or second branch 310, images the intermediate focus IF onto detector surfaces of 2D PSD sensors 325. This second branch 310 may be referred to as the IF imaging branch.

As illustrated in FIG. 4, the first surface S1 of the detector 301 includes a plurality of mirrors 320 that image the intermediate focus IF onto 2D PSD's 325 disposed on the PFM frame or second surface S2. In this manner, it is possible to determine the X and Y location of the light distribution at the intermediate focus IF, determined by plasma-X and -Y positioning (with respect to the collector) and rigid-X and -Y positioning. Rotation of the source module SO around the intermediate focus IF will not be detected because the path of rays traversing the mirror 320 does not change under such a rotation. As a result, by using the second branch 310, it is possible to separate between rigid-X and -Y movements, and rigid-Ry and -Rx movements. In order to carry out a measurement, with this second branch 310, of displacements in accordance with the rigid X and Y degrees of freedom, a use of just one mirror-PSD pair can be sufficient. Here a mirror-PSD pair is a pair consisting of a mirror and the PSD onto which that mirror projects an image of the intermediate focus IF. The plasma-X and -Y positions can be determined as well when at least one extra mirror and PSD pair is used, in which case it is desirable that the two pairs be perpendicularly oriented as shown in FIG. 6. FIG. 6 illustrates two such mirror-PSD pairs 610 and 620, respectively consisting of the mirror 320a and 2D PSD 325a and the mirror 320b and 2D PSD 325b. The arrangement of detectors as shown in FIG. 6 enables an alternative way of measuring the plasma-X and -Y displacements.

By using the fact that the sagittal and meridional magnifications of the plasma are different for marginal rays (e.g., rays that traverse the far field close to the outer edge of the far field, where the field facet mirrors are positioned), it is possible to separate plasma-X and -Y movements from and rigid-X and -Y movements.

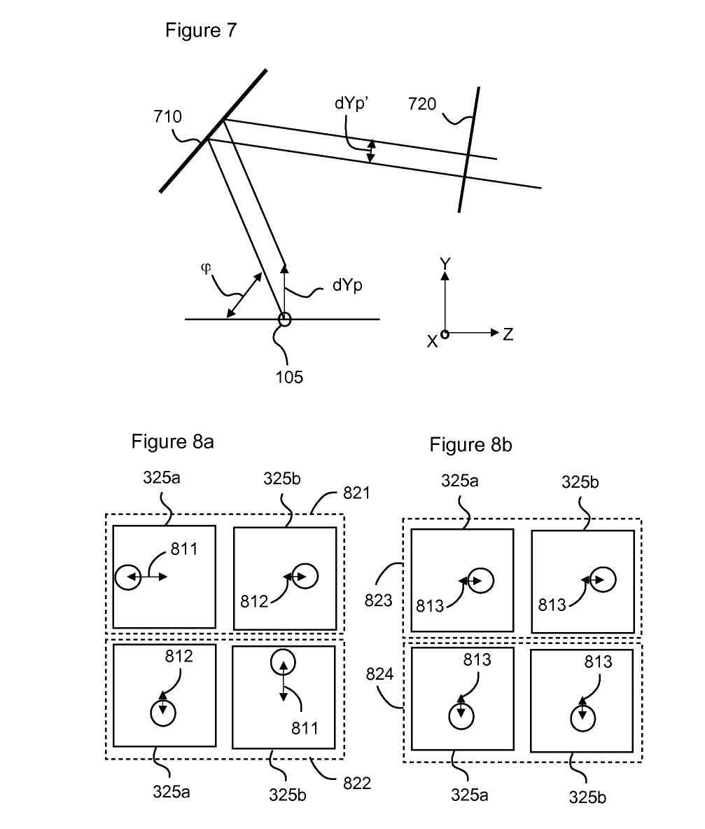

The difference between sagittal and meridional magnifications is illustrated in FIG. 7. FIG. 7 shows a flat mirror 710. As shown in FIG. 7, a plasma movement dYp in the Y direction is magnified by the cosine of the angle φ: dYp′=dYp*cos(φ). This cosine factor is only applicable when the movement lies within the plane defined by the incoming and reflected ray. In this case, the movement is within the meridional plane and the magnification associated with it is called the meridional magnification (in this case cosine φ). In the extreme case that the ray angle is 90 degrees, the movement is parallel to the ray and hence the magnification becomes zero; as predicted by the fact that the cosine of 90 equals 0.

The sagittal movement describes the magnification changes for the movement in the X direction; e.g., perpendicular to the meridional plane. The associated magnification is referred to as the sagittal magnification. Referring to FIG. 7, and assuming the movement to be inwards (X-direction), the movement at a notional screen 720 would be in the X direction as well and the magnification would be 1, irrespective of the ray angle φ.

Since the source collector CO has an acceptance solid angle of about 5 Sr for radiation emitted by the plasma, the difference between a meridional and a sagittal magnification of plasma movements is relatively large for the marginal rays compared to the difference between a meridional and a sagittal magnification for on-axis rays.

The radial displacement of the far field edge is proportional to the plasma displacement and the meridional magnification. The meridional magnification only determines the radial magnification of a plasma movement. Since this meridional magnification varies substantially between the inner and outer edges, it is possible to use this to discriminate between rigid and plasma movements, as shown in FIG. 4.

For marginal rays, the sagittal and meridional magnifications may be significantly different. Measuring the location of the plasma image at orthogonally oriented mirror-PSD pairs allows one to calculate the plasma movement. If a plasma movement is a sagittal movement for a particular mirror-PSD pair, then, this indicates a meridional movement for the other mirror-PSD pair since the PSDs look at the movement along two orthogonal planes.

When two sensors do not detect the same image shift, this indicates that the plasma has moved. Using the known magnifications, it is possible to calculate the plasma movement (direction and magnitude). This principle is shown in FIG. 10, which assumes that one mirror-PSD pair lies within the Y,Z-plane and another mirror-PSD pair lies within the X,Z-plane. It will be appreciated that for any other orthogonal orientation, a similar decomposition can be made into sagittal and meridional movements. With reference to FIG. 6, the mirror 320a (just for simplicity schematically drawn as a lens), and the 2D PSD 325a together form the mirror-PSD pair lying in the Y,Z-plane, and similarly, the pair mirror 320b-2D PSD 325b together form the mirror-PSD pair lying in the X,Z-plane. The 2D PSD 325a is referred to as the Y-sensor, and the 2D PSD 325b is referred to as the X-sensor. In addition to FIG. 6, FIG. 8 schematically indicates a detection scheme using two orthogonal sensor-mirror pairs to separate rigid and plasma movements in accordance with an embodiment of the invention.

The double arrows in FIG. 8a illustrate displacements 811 and 812 of the image of the emission point 105 on the Y- and X-sensor as a result of plasma movements. Images of the light spot at intermediate focus IF on the 2D PSD's are shown as circles in FIG. 8. One endpoint of the double arrows is centered at the light spots before plasma movement; the corresponding light spots are not shown. The displacements are indicated by the arrows 811 and 812 in FIG. 8a, and the relative magnitudes of the displacements by the relative lengths of the arrows 811 and 812. The displacements have different magnitudes, displacement 811 being larger than displacement 812. An effect of plasma-X and -Y movements are shown in the groups 821 and 822 of image displacements, respectively. Similarly, an effect of rigid-X and -Y movements are shown in the groups 823 and 824 of image displacements, respectively. In particular, a plasma-X movement results in a displacement 811 on the Y-sensor 325a, and a displacement 812 on the X-sensor 325b. In contrast, FIG. 8b shows a displacements 813 of the image of the emission point 105 on the Y- and X-sensor as a result of rigid movements, i.e., a movements of the source module with respect to the illuminator. The displacements are indicated by the arrows 813 in FIG. 8b and have each the same magnitude. In particular, a rigid-X movement results in a same X-displacement 813 on both the Y-sensor and the X-sensor, and similarly, a rigid-Y movement results in a same Y-displacement 813 on both the Y-sensor and the X-sensor.

A combination of image displacements as illustrated in FIG. 8a is indicative for a plasma movement. In the present example, the magnification determining the displacement 812 was 1, and the magnification determining the displacement 811 was 6.2. The corresponding plasma movement (direction and magnitude) can be calculated using these system characteristic magnifications and the measured displacements 811 and 812.

Similarly, a combination of image displacements as illustrated in FIG. 8b is indicative for a rigid movement. In the present example, the magnification determining the displacement 813 was 1, and the corresponding rigid movement (direction and magnitude) can be calculated using this system characteristic magnification and the measured displacements 813. Hence using two pairs of mirror-PSD, disposed in two respective orthogonal planes, enables separating rigid and plasma movements and calculating the magnitude and direction of these rigid and plasma movements.

### Example 1

on the Y-sensor, a Y-displacement of 10 mm is measured and a X-displacement of 10 mm is measured. On the X-sensor, 10 mm X- and Y-displacements are also measured. Conclusion: a 10 mm rigid-X and -Y movement is the cause of the observed behavior because there is no variation observed between the X and Y sensors.

### Example 2

on the Y-sensor, a Y-displacement of 1 mm is measured and a X-displacement of 10 mm is measured. On the X-sensor, 1.6 mm X- and 1 mm Y-displacements are measured. Conclusion: a 1 mm rigid-Y and a 1.6 mm plasma-X movement are the causes of the observed behavior. The X-plasma movement is causing a larger shift on the Y-sensor than on the X-sensor. This is caused by the fact that for the Y-sensor an X-movement is a sagittal movement (large magnification factor) and for the X-sensor an X-movement is a meridional movement (small magnification factor).

The edge detection method of plasma-X and -Y determination uses the fact that the collector shows a large difference in meridional magnification between on-axis and marginal rays while for the 2D-PSD method an identification of the plasma movement, separate from a rigid movement) relies on the fact that the collector has very different sagittal and meridional magnifications for the marginal rays.

The detectors and radiation sources described so far have been described as being in a fixed positional relationship with a part of the illuminator relative to which the collector is to be aligned. The detectors and/or the radiation sources can be located within, and/or attached to the illuminator or the part of the illuminator.

The embodiments described above can be combined. In the above embodiments, the collector that has been described is formed by, for example, a concave reflective surface. In embodiments where an additional radiation source is used to direct radiation at a region of the collector and a detector is then used to detect changes in radiation reflected from this region, the collector can also be, for example, a grazing incidence collector. The region can be a part of, or attached to, a constituent part of the grazing incidence collector. Additional and/or more accurate positional and/or orientation information can be obtained by using, for example, additional detectors.

The alignment of the collector relative to the illuminator can be undertaken at any appropriate time. For instance, in an embodiment, the alignment can be undertaken during a calibration routine undertaken in respect of a part of, or all of, the lithographic apparatus. The alignment can be undertaken when the lithographic apparatus has not been used to apply a pattern to a substrate. The alignment can be undertaken when a lithographic apparatus is actuated for the first time, or after a period of prolonged inactivity. The alignment can be undertaken when, for example, parts of the collector or illuminator are replaced or removed (e.g., during a maintenance routine or the like). In an embodiment, a method of aligning the collector and a part of the illumination system can include the following: detecting radiation directed from the region with which the collector is provided; determining from that detection whether the collector is aligned with the part of the illumination system; and, if the collector is not aligned with the part of the illumination system, moving the collector or the part of the illuminator. After moving the collector or the part of the illuminator, the method can be repeated.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. It should be appreciated that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

The invention is not limited to application of the lithographic apparatus or use in the lithographic apparatus as described in the embodiments. Further, the drawings usually only include the elements and features that are necessary to understand the invention. Beyond that, the drawings of the lithographic apparatus are schematically and not on scale. The invention is not limited to those elements, shown in the schematic drawings (e.g. the number of mirrors drawn in the schematic drawings). Further, the invention is not confined to the lithographic apparatus described in FIGS. 1 and 2. The person skilled in the art will understand that embodiments described above may be combined.

1. A lithographic apparatus comprising:
a source module including a collector and a radiation source constructed and arranged to provide, in use, a radiation emitting plasma, the collector configured to collect radiation from the radiation emitting plasma;
an illuminator configured to condition the radiation collected by the collector and to provide a radiation beam; and
a detector disposed in a fixed positional relationship with respect to the illuminator, the detector configured to determine a position of the radiation emitting plasma relative to the collector and a position of the source module relative to the illuminator.

2. The apparatus of claim 1, wherein the detector is configured to measure the position of the radiation emitting plasma relative to the collector in three independent translational degrees of freedom.

3. The apparatus of claim 2, wherein the detector is configured to measure the position of the source module relative to the illuminator in five degrees of freedom including three independent translational degrees of freedom and two independent rotational degrees of freedom.

4. The apparatus of claim 1, wherein the detector includes a first branch including a plurality of first sensors mounted to a first surface of the illuminator, the plurality of first sensors configured to determine the position of the radiation emitting plasma relative to the collector.

5. The apparatus of claim 4, wherein the first sensors are constructed and arranged to sense along one direction a position of a change of incident radiation intensity.

6. The apparatus of claim 5, wherein the first sensors include a sensor configured to sense a position of an inner edge of the beam of radiation reflected by the collector and another sensor configured top sense a position of an outer edge of the beam of radiation reflected by the collector.

7. The apparatus of claim 6, wherein the inner edge is an inner bright-dark radiation intensity change, and wherein the outer edge is an outer bright-dark radiation intensity change.

8. The apparatus of claim 4, wherein the detector includes a second branch including a plurality of second sensors mounted to a second surface of the illuminator, the plurality of second sensors configured to determine the position of the source module relative to the illuminator.

9. The apparatus of claim 8, wherein the second sensors are constructed and arranged to sense along two directions a position of a change of incident radiation intensity.

10. A device manufacturing method comprising:
using a radiation source to generate a radiation emitting plasma;
collecting the radiation generated by the radiation emitting plasma with a collector, the radiation source and the collector being part of a source module of a lithographic apparatus;
conditioning the radiation collected by the collector with an illuminator to provide a radiation beam; and
detecting a position of the radiation emitting plasma relative to the collector and a position of the source module relative to the illuminator.

11. The method of claim 10, further including detecting a rotational orientation of the source module relative to the illuminator.

12. The method of claim 11, wherein a detector used for the detecting includes a first branch including a plurality of first sensors mounted to a first surface of the illuminator, the plurality of first sensors configured to determine the position of the radiation emitting plasma relative to the collector and the rotational orientation of the source module relative to the illuminator.

13. The method of claim 12, wherein the detector further includes a second branch including a plurality of second sensors mounted to a second surface of the illuminator, the plurality of second sensors configured to determine the position of the source module relative to the illuminator.

14. A detector configured to determine a position of a radiation emitting plasma relative to a collector and a position of a source module relative to an illuminator in a lithographic apparatus, the source module including the collector and a radiation source constructed and arranged to provide the radiation emitting plasma, the collector configured to collect radiation from the radiation emitting plasma, and the illuminator configured to condition the radiation collected by the collector and to provide a radiation beam, the detector comprising:
a first branch including a plurality of first sensors mounted to a first surface of the illuminator, the plurality of first sensors configured to determine the position of the radiation emitting plasma relative to the collector and a rotational orientation of the source module relative to the illuminator; and
a second branch including a plurality of second sensors mounted to a second surface of the illuminator, the plurality of second sensors configured to determine the position of the source module relative to the illuminator and the position of the radiation emitting plasma relative to the collector.
